(19) United States
(12) Patent Application Publication
(10) Pub. No.: US 2001/0004768 A1
(43) Pub. Date: Jun. 21, 2001

(54) Highly integrated computer controlled digital head end

(76) Inventors: Winston W. Hodge, Yorba Linda, CA (US); William H. Darnall, Costa Mesa, CA (US)

Correspondence Address: Michael A. Kerr, P.O. Box 2345, Stateline, NV, 89449, US

(21) Appl. No.: 09/761,205

(22) Filed: Jan. 16, 2001

Related U.S. Application Data
(63) Continuation-in-part of application No. 09/162,313, filed on Sep. 28, 1998.

(51) Int. Cl. H04N 7/173

(52) U.S. Cl. 725/91; 725/98

(57) ABSTRACT

The present invention is a highly integrated computer controlled digital headend configured to process a plurality of digital video, a plurality of digital data, a plurality of voice information, and a plurality of upstream communications. The digital headend includes at least one smart network interface module operatively coupled to a shared bus, a downstream module and an upstream module. Preferably, the smart network interface module is configured to receive, transfer and buffer the plurality of digital video, the plurality of digital data, the plurality of voice information and the plurality of upstream communications. The shared bus is operatively coupled to the at least one smart network interface module. The shared bus is configured to transport the digital video, the plurality of digital data, the plurality of voice information, and the plurality of upstream communications. The downstream module is operatively coupled to the shared bus. The downstream module is configured to transmit the plurality of digital video, the plurality of digital data and the plurality of voice information. It shall be appreciated by those skilled in the art having the benefit of this disclosure that the smart network interface module may be a discrete module operatively coupled to the shared bus or the smart network interface module may be resident on the downstream module, or any combination thereof. The upstream module is operatively coupled to the shared bus and is configured to receive the plurality of upstream communications.

The present invention is a Continuation-In-Part of patent application Ser. No. 09/162,313 filed on Sep. 28, 1998 and titled “Interactive Digital Program Encoder and System”.

### BACKGROUND OF THE INVENTION

1. Field of the Invention

The present invention relates to a broadband hardware apparatus. More particularly, the present invention is a digital headend which receives and processes video, data and voice signals.

2. The Prior Art

There are four main types of broadband technologies which include digital television (DTV), satellite, cable and digital subscriber lines (DSL). These four main broadband technologies provide new opportunities for transport and content providers, advertisers, consumer electronics companies, and consumers.

Broadband technologies can be classified as either one-way or two-way. One-way technologies send digital information to the end user at very high speeds, but rely on some other means (usually an analog modem and a phone line) to receive information from the end user. One-way broadband technologies include digital television (DTV) and satellite. Two-way broadband technologies, such as cable and digital subscriber lines (DSL) send and receive digital information at very high speeds over the same medium. Two-way broadband technologies usually require a wired infrastructure.

Broadband technologies transfer sounds and images as a series of digital signals which are more noise-immune and reliable than analog communications. Additionally, when compressed data is transferred digitally, it takes up much less space than analog data. This effective increase in bandwidth can be used to provide services which deliver Internet content faster, deliver compelling next generation content like streaming IP, deliver video and data to add interactivity to television, improve the display resolution of traditional TV programming (HDTV), and add more content. Digital transfer allows at least four standard definition channels to occupy the same space that one analog channel occupies today.

Cable companies are in the process of transitioning from a one-way analog broadcast network to a two-way broadband digital network. However, this transition has proven to be costly due to the disparate systems using different communications protocols and the problems associated with system integration. A modular and scalable headend system which combines voice, data, and video is not presently available to cable companies. Additionally, commercially available headend systems are not readily configurable, thus the commercially available headend systems provide a limited number of services. Generally, present headend systems also have narrow bandwidth back channels which further limits the number of available services. Finally, the present day digital headend equipment can not guarantee the quality of service (QoS) for a broadband network which is configured to provide for the convergence of video, voice, and data communications.

FIG. 1 shows an illustrative prior art digital headend system 10 which is configured to provide two-way broadband communications. The data communicated and processed by the digital headend 10 includes analog video 12, Internet data 14, and digital video 16. An analog video signal 12 is received by a first upconverter 18. Those skilled in the art shall appreciate that the upconverter provides the appropriate RF communication frequency range for downstream transmission via a cable and/or HFC distribution network to a set top box. Additionally, those skilled in the art shall also appreciate that during upstream communications, a QPSK demodulator (not shown) is used to demodulate the upstream signals for communication with the digital headend.

In the digital headend system 10, the Internet data 14 received by the digital headend 10 is communicated to a central processing unit (CPU) 20 and a point-of-presence (POP) cable modem termination system (CMTS) 22. The CPU 20 performs the function of providing menuing information, conducting accounting and billing, and managing the conditional access control. The CMTS 22 is a data-over-cable service interface specification (DOCSIS) compliant cable headend router which provides an Internet Protocol (IP) standard which allows a plurality of cable modems (not shown) to communicate with the CMTS 22. Downstream data from the CMTS 22 is then communicated to a quadrature amplitude modulation (QAM) modulator 24. The QAM modulator 24 provides a method for modulating digital signals onto an intermediate RF carrier signal involving both amplitude and phase coding which is then communicated to a second upconverter 26. As previously mentioned, the upconverter 26 provides the function of translating QAM modulated data at the appropriate frequency as a plurality of downstream signals. Upstream signals 28 generated by a cable modem (not shown) are then received by a Quadrature Phase-Shift Keying (QPSK) demodulator 30 on the digital headend 10. The QPSK demodulator 10 demodulates digital signals from a RF carrier signal using four phase states to code two digital bits. The digital output from the QPSK demodulator 30 is communicated to the CPU 20 and an out-of-band QPSK modulator 32. The out-of-band (OOB) QPSK modulator 32 provides bi-directional signaling for broadband communications as would be appreciated by those skilled in the art. The OOB QPSK modulator 32 is operatively coupled to an upconverter 34.

The digital video data 16 received by the digital headend 10 is received by the control computer 36 and by a video server 38. Under the guidance of the control computer 36, the video server 38 transmits digital video signals to a QAM modulator 40 which communicates the modulated data to an upconverter 42. The upconverter 42 translates the digital video data at the appropriate downstream frequency for subsequent transmission to a set-top box (not shown). Upstream communications generated by the digital set-top box are communicated to a QPSK demodulator (not shown) which is dedicated to digital video.

The control computer 36 manages the dynamics of digital headend and the Internet data, digital video data and analog data by processing the upstream communications from the set top boxes or cable modems. Further still the control computer 36 determines what movies are loaded onto the video server 38.

It shall be appreciated by those of ordinary skill in the art that an upconverter level adjuster 42 is employed to adjust the level for RF signals communicated by each respective upconverter 18, 34, 42, and 26.

Although not shown, telephony services may also be included in the digital headend shown in FIG. 1. If telephony services were added to the headend described above, they could be provided with a conventional switched telephony system or a voice over IP (VoIP) telephony system. The prior art telephony systems which interface with the digital headend 10 would generally employ downstream QAM modulators with upconverters and upstream QPSK demodulators.

The prior art digital headend system 10 has little or no modularity built into the system. Modularity is defined as the property which provides functional flexibility to a computer system by allowing for the assembling of discrete software units which can be easily joined or arranged with other hardware parts or software units. For example, the prior art digital headend system includes a CMTS 22 which receives Internet data in the form of Ethernet frames using the IP protocol and employs an MPEG-2 transport stream. Additionally, the prior art digital headend 10 includes the digital video 16 which is received as an MPEG-2 transport stream and this MPEG-2 transport stream is also used to communicate the digital video 16 to a set-top box (not shown). Although Internet data and digital video data use the same MPEG-2 transport stream, these two data streams have nor been cost effectively integrated. For the co-existence of these two data streams to occur a separate stand alone intermediary hardware and software solution is necessary. The intermediary hardware and software solution does not provide a modular platform.

Therefore, it would be beneficial to provide a digital headend system which can integrate digital video, digital data, digital voice signals and upstream communications signals into one digital headend without the use of an intermediary hardware and software solution.

Furthermore, it would be beneficial to provide a two-way broadband system which can be optimized by using shared resources.

Additionally it would be beneficial to provide a digital headend system which can centrally manage control data associated with the digital video, digital data, digital voice and upstream communications signals.

Further still, it would be beneficial to provide a digital headend system which can combine digital video and digital data services.

Further still, it would be beneficial to provide a digital headend system which can combine digital video, digital data and digital voice services.

### SUMMARY OF THE INVENTION

The present invention is a versatile digital cable system that includes a highly integrated computer controlled headend. The highly integrated computer controlled headend comprises a shared bus that permits a high level of integration between video, data and voice. The highly integrated computer controlled headend comprises a highly integrated system having an first-level buffering operation which takes full advantage of the shared bus and other shared resources.

The present invention is a highly integrated computer controlled digital headend configured to process a plurality of digital video, a plurality of digital data, a plurality of voice information, and a plurality of upstream communications. The digital headend includes at least one smart network interface module operatively coupled to a shared bus, a downstream module and an upstream module. Preferably, the smart network interface module is configured to receive, transfer and buffer the plurality of digital video, the plurality of digital data, the plurality of voice information and the plurality of upstream communications. The shared bus is operatively coupled to the at least one smart network interface module. The shared bus is configured to transport the digital video, the plurality of digital data, the plurality of voice information, and the plurality of upstream communications. The downstream module is operatively coupled to the shared bus. The downstream module is configured to transmit the plurality of digital video, the plurality of digital data and the plurality of voice information. Preferably, the smart network interface module is operatively coupled to the shared bus. It shall be appreciated by those skilled in the art having the benefit of this disclosure that the smart network interface module may be a discrete module resident on the downstream module. The upstream module is operatively coupled to the shared bus and is configured to receive the plurality of upstream communications.

The highly integrated computer controlled digital headend is part of a two-way broadband system, comprising the highly integrated computer controlled digital headend, a cable distribution network and a set-top box. The cable distribution network is in communication with the digital headend. The cable distribution network is configured to communicate the plurality of digital video, the plurality of digital data, the plurality of voice information, and the plurality of upstream communications. The set-top box is configured to receive the plurality of digital video, or the plurality of digital data, or the plurality of voice information. Additionally, the set-top box is configured to generate the plurality of upstream communications.

### BRIEF DESCRIPTION OF DRAWING FIGURES

FIG. 1 is an illustrative prior art two-way broadband digital headend system.

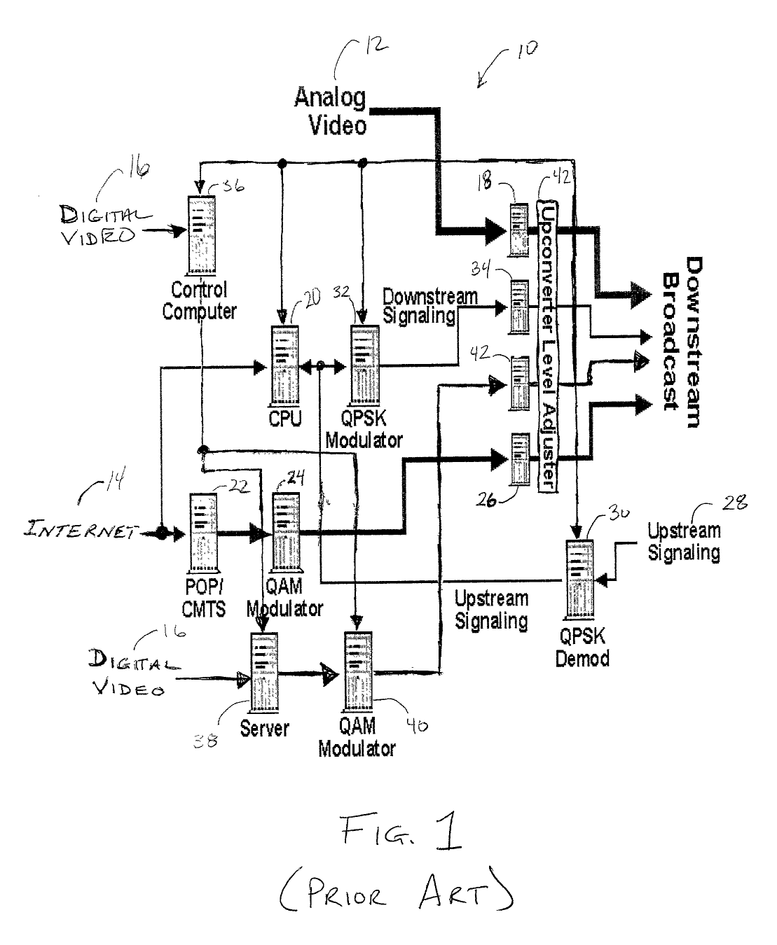

FIG. 2 provides a comparison between an illustrative traditional piecemeal digital headend and a highly integrated computer controlled headend with system buffering in a shared environment.

FIG. 3 is a high level block diagram of a cable system having the highly integrated computer controlled headend.

FIG. 4 is a detailed block diagram of the highly integrated computer controlled headend with system buffering in a shared environment.

FIG. 5 is a flowchart showing the data flow through the highly integrated computer controlled headend with system buffering in a shared environment.

### DETAILED DESCRIPTION OF THE INVENTION

Persons of ordinary skill in the art will realize that the following description of the present invention is illustrative only and not any way limiting. Other embodiments of the invention will readily suggest themselves to such skilled persons having the benefit of this disclosure.

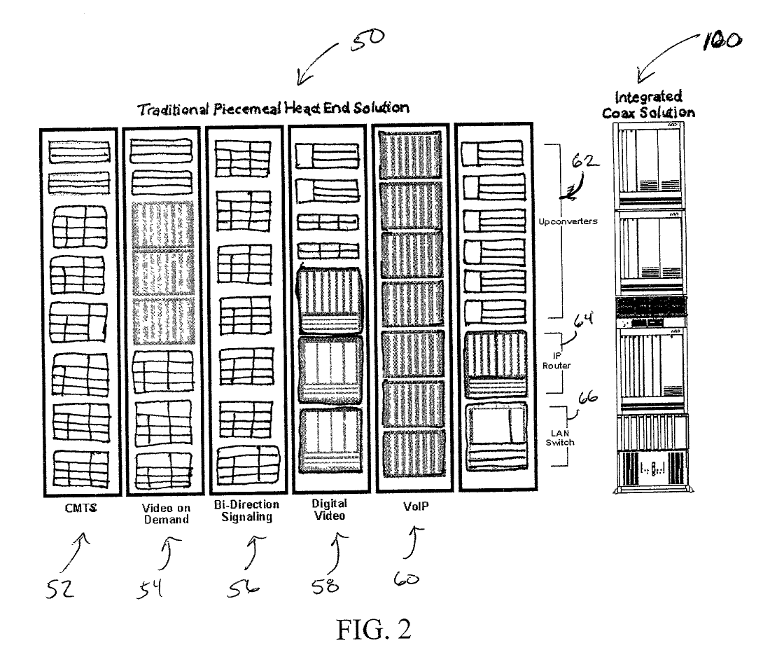

The present invention is a versatile digital cable system that comprises a hardware platform configured to run a plurality of applications for a two-way broadband system. Referring to FIG. 2 there is shown a comparison between an illustrative traditional piecemeal digital headend 50 and a digital headend 100 of the present invention which is also referred to as a highly integrated computer controlled headend 100. The illustrative prior art digital cable headend hardware system 50 comprise isolated pieces of equipment such as an isolated CMTS system 52, an isolated Video-on-Demand system 54, an isolated Bi-directional signaling system 56, a digital video system 58, a voice over IP system, and a plurality of upconverters 60, an IP router 62 and a LAN switch 64.

By comparison, the highly integrated computer controlled headend 100 includes a system for buffering video, data and voice signals which unifies the digital functions of these prior art individual systems and pieces of equipment. Additionally, the highly integrated computer controlled headend 100 provides a hardware platform which centrally controls all functions in the digital headend and uses the same digital headend hardware 100 to enable novel applications for the highly integrated computer controlled headend with software, thereby avoiding the need for intermediary hardware platforms.

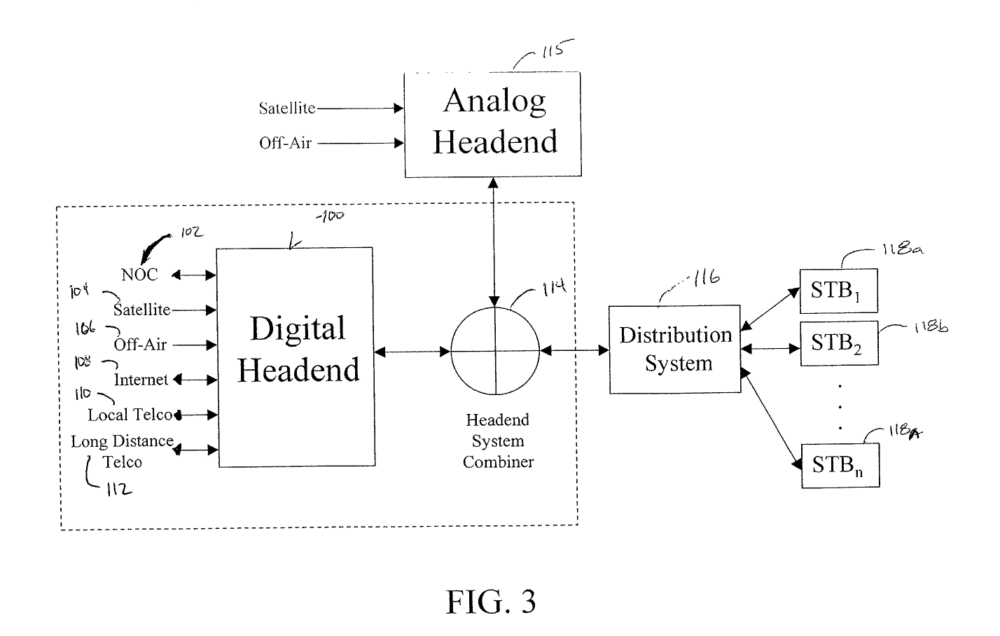

Referring to FIG. 3 there is shown a high level block diagram of a cable system in which the highly integrated computer controlled headend 100 of the present invention is employed. In the preferred embodiment, the highly integrated computer controlled headend 100 provides the following functions: communicating with a Network Operations Center (NOC) 102; receiving signals from a satellite 104; receiving off-air transmission 106; receiving and transmitting Internet data 108; receiving and transmitting local telephony signals 110 and long distance telephony signals 112, and communicating with a headend system combiner 114.

To perform the functions described above the highly integrated computer controlled headend 100 performs video, data, and voice processing. The video, data, and voice processing performed by the highly integrated computer controlled headend 100 include downstream and upstream signal processing, i.e. bi-directional signal processing. Additionally, the highly integrated computer controlled headend 100 includes a control system which is configured to regulate or “control” the downstream and upstream signal processing.

It shall be appreciated by those skilled in the art having the benefit of this disclosure that the control data processed by the highly integrated computer controlled headend 100 is NOT solely generated by the highly integrated computer controlled headend 100. Those skilled in the art will recognize that the control data processed by the highly integrated computer controlled headend 100 may also include control data which is provided by other systems communicating with the highly integrated computer controlled headend 100, such as the NOC and the plurality of set-top boxes.

The highly integrated computer controlled headend 100 is an element of a system which will likely include a NOC (not shown), a headend system combiner 114, an analog headend 115, a distribution network 116, and a plurality of set-top boxes 118a through 118n. The headend system combiner 100 is operatively coupled to the highly integrated computer controlled headend 100 and the analog headend 115. The analog headend 115 receives broadcast signals from satellite transmissions 120 or from off-air antenna transmissions 122. Furthermore, the headend system combiner is configured to combine the signals generated by the analog headend 115 with the signals generated by the highly integrated computer controlled headend 100. The headend system combiner is also operatively coupled to the distribution network 116 which includes a plurality of amplifiers, nodes, coaxial cable and/or optical fiber to distribute output from the headend system combiner 114 to one or more set top boxes 118a through 118n.

The one or more set-top boxes 118a through 118n are configured to receive the plurality of digital video, or the plurality of digital data, or the plurality of voice information. Additionally, the set-top box is configured to generate the plurality of upstream communications.

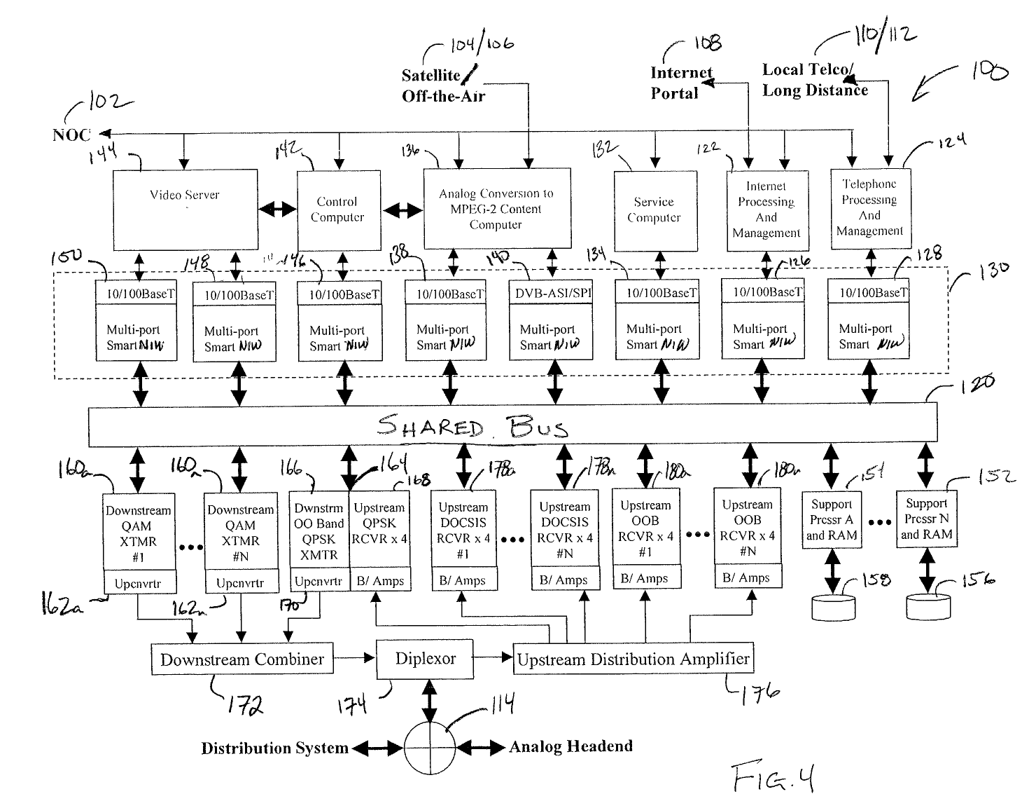

Referring to FIG. 4 there is shown a detailed block diagram of the highly integrated computer controlled headend 100 which is also referred to as the digital headend. The highly integrated computer controlled headend 100 comprises a shared bus 120 that permits a high level of integration between video, data and voice signals. Digital video signals provide the representation of video signals in a digital format. Digital data signals are generally communicated in compliance with the data-over cable service interface specification (DOCSIS). DOCSIS is the cable modem standard produced by an industry consortium led by Cable Labs. It shall be appreciated by those skilled in the art having the benefit of this disclosure that the MPEG-2 transport stream is, preferably, employed for communicating said digital video signals and said digital data signals. Voice signals are generally communicated as voice over Internet Protocol (VoIP) or conventional switched telephony. VolP provides the ability carry normal telephony-style voice over an IP-based Internet with POTS-like voice quality. It shall be appreciated by those skilled in the art having the benefit of this disclosure that VoIP can be represented as either digital data signals. It shall also be appreciated by those skilled in the art that VoIP voice signals are generally communicated using the MPEG-2 transport stream, however, conventional switched telephony systems may also be used with the digital headend 100. Therefore, voice signals refers to both VoIP and conventional switched telephony.

Preferably, the shared bus 120 is a parallel bus such as a 32-bit Compact PCI-bus. The 32 bit Compact PCI-bus allows for the use of a combination of off-the-shelf systems which are integrated with downstream modules and upstream modules of the present invention. Since the Compact PCI-bus can only hold a fixed number of modules, a plurality of Compact PCI chassis may be used to satisfy additional system demands, and thereby provide for system scalability. It shall be appreciated by those skilled in the art having the benefit of this disclosure that a 64-bit Compact PCI bus or any other parallel bus may be used. Alternatively, the shared bus 120 may be a high speed serial bus. Regardless of the type of bus employed, it is essential that the bus architecture which provides for the sharing of resources operates in a manner which is open and scalable.

The downstream content which is processed by the highly integrated computer controlled beadend 100 is generated by a network operations center (NOC) 104, a satellite or off-the-air broadcast 106, an Internet Portal 108, a local telephone company portal 110 and a long distance telephone company portal 112. The NOC 104 provides a variety of different types of information which include content streams for the highly integrated computer controlled headend 100, security procedures such as cryptography, billing information, and post processing work. The satellite or off-the-air broadcast 106 provides the video signals which are communicated using well known RF signalling methods. The portals, i.e. Internet portal 108, local telephone company 110 and long distance telephone company 112, receive and transmit information to the highly integrated computer controlled headend 100.

An Internet processing and management system 122 is in communication with the NOC 104 and the Internet portal 108. A telephone processing and management system 124 is in communication with the NOC 104, the local telephone company portal 110 and long distance phone company portal 112. Well known Internet and telephone processing and management systems 122 and 124, respectively, have been developed by companies such as Cisco Systems and Texas Instruments. The Internet process and management system 122 provides processing and management for Internet data. The telephone process and management system 124 provides processing and management of either switched telephony or VoIP signals.

Both of the Internet and telephony processing and management systems 122 and 124, respectively, are operatively coupled to the shared bus 120 via a smart network interface module (NIM) 126 and 128, respectively. Preferably, the smart NIMs 126 and 128 provides a first level of buffering which optimizes the bus transfer rate of the shared bus 120. Alternatively, the smart NIMs 126 and 128 reside on a plurality of downstream modules.

It shall be appreciated by those of ordinary skill in the art that a “bus” is a series of tiny wires that run from one chip to another. The shared bus 120 of the present invention provides an architecture which allows the headend 100 to share headend resources. The shared bus includes address, data and control elements which are communicated in a serial bus or parallel bus. A serial bus has fewer wires and operates generally at a higher speed. A parallel bus has more wires and generally operates at a slower speed. Any combination of a serial bus and parallel bus may also be employed. Preferably, the shared bus employs a 32-bit Compact PCI bus which is a parallel bus.

Although the preferred embodiment of the present invention employs a smart NIM configured to optimize communications across the shared bus, other devices which do not employ a CPU but which provide buffering may also be employed. These devices may include only memory devices which are configured to buffer video, data and voice signals. For purposes of this patent application, the term smart NIM is not restricted to NIM having a CPU. As described in this patent application, the term the smart NIM refers to a controller which is configured to buffer digital information received by that smart NIM. Preferably, the buffered digital information is optimized by the smart NIM for transfer across the shared bus.

The smart NIMs 126 and 128 are coupled to the Internet and telephony processing and management system 122 and 124, respectively, and provide the first level buffering which controls the blocks of data which are communicated across the shared bus 120. Preferably, the smart NIMs 126 and 128 efficiently manage the transmission of bus traffic using block transfer to communicate data across the shared bus 120. By optimizing the data being transferred across the shared bus 102, the smart NIM avoids efficiency losses caused by serial connections between disparate system components. Judicious data management provided by the smart NIM optimizes communications within the highly integrated computer controlled headend 100 by managing the communications between the various components of the highly integrated computer controlled headend 100.

A service computer 132 is in communication with the NOC 104. The service computer 132 performs the function of managing the conditional access, billing and configuration management. Configuration management determines the type of equipment deployed and its maintenance history. The service computer is a robust dedicated general purpose computer. Communications with the shared bus system 132 are accomplished with a Smart NIM 134 which provides appropriate buffering to optimize communications along the Compact PCI bus 120 as described in the body of this specification.

An MPEG content computer 136 receives the satellite 104 and off-the-air signals 106 and converts these analog signals to digital video signals using, preferably, an MPEG digital format. The MPEG content computer 136 also receives ad insertion feeds and converts these feeds to a digital content stream which are inserted into the local (off-the-air) content and the satellite feed content 106. The digital content generated by the MPEG content computer 136 is then fed to a 10/100 BaseT interface which, preferably, provides a MPEG-2 transport stream to a smart NIM 138. Additionally, the digital content generated by the MPEG content computer 136 is also fed to a DVB-ASI/SPI interface operatively coupled to a smart NIM 138 which also uses a MPEG-2 transport stream. As previously described, the smart NIM provides the first level buffering which optimizes the bus transfer rate to the shared bus 120.

The control computer 142 receives control information provided by the NOC 104. The control information includes a program guide, generated at the NOC 104, which is communicated by the highly integrated computer controlled headend 100 to a plurality of set-top boxes 118a through 118n. The control computer 142 also performs the real-time functions of content management and resource allocation for the MPEG content streams. The control computer 142 is a relatively quick and robust computer system compared to the service computer 122. The content management regulated by the control computer 142 comprises the MPEG content from a video server 144 and the MPEG content computer 136. The resource allocation provided by the control computer 142 manages system resources for the highly integrated computer controlled headend 100. The control computer is operatively coupled via a 10/100 BaseT interface to a smart NIM 146 which is operatively coupled to the shared bus 120.

The video server 144 receives content from the NOC 104 or from the MPEG content computer 136. The video server 144 provides local storage for digital video. As previously described, the video server 144 is managed by the control computer 142. The output from the video server 144 is communicated to smart NIMs 148 and 150. The smart NIMs 148 and 150 provide the first level buffering which optimizes the bus transfer rate to the shared bus 120.

A plurality of support processors 152 and 154 having appropriate memory resources are resident as modules which are configured to interface with the shared bus 120. Each support processor 152 and 154 is operatively coupled to disk drives 156 and 158, respectively. Each of the support processors 152 and 154 operate as an individual computer which are operatively coupled to the shared bus 120. The support processors 152 and 154 contain configuration information for the upstream and downstream modules (described below). Additionally the support processors 152 and 154 and their associated disk drives 156 and 158 also contain software programs for the upstream and downstream modules. The support processors 152 and 154 provide the preferred alternative to managing the addition of software to the highly integrated computer controlled headend 100. By way of example and not of limitation, hundreds of utility programs keep track of time of day, memory addresses, and are responsible for managing the downloading of software to the upstream and downstream modules. When loading software onto the downstream and upstream modules, it is important to avoid loading viruses or other types of software onto the system which will affect the performance of the highly integrated computer controlled headend 100 and the set-top boxes which receive the new software.

More particularly, the process for installing software onto the downstream modules or upstream modules or the set-top boxes includes first receiving software on one of the support processors 152 or 154. The received software is then tested locally on the support processor 152 or 154 to make sure the software is “clean”. A downstream or upstream module is then taken out of service and then loaded with the new software. Diagnostics are performed to make sure the module is operating properly. Once the module has successfully passed the self-test, the module is brought back on-line. When the module is taken off-line and put back on-line, one of the support processors communicates the status of the module to the service computer 132. After the completion of loading the software on the appropriate downstream module or upstream module, the support processor may then move onto the next module and proceed in a similar manner as described above. In general each support processor 152 and 154 communicates the status on each of the downstream and upstream modules to the service computer 132 which in turn communicates this information to the network operations center 104.

The highly integrated computer controlled headend 100 also includes an advanced digital down stream data module 160a through 160n and 166. The advanced digital downstream data modules 160a through 160n provide a highly integrated QAM functionality which improves the management of downstream data, increases reliability for the transmission of the downstream data, and provides for better utilization of available bandwidth. The advanced digital downstream data modules 160a through 160n each comprise a dedicated high-speed embedded processor, an onboard memory, an upconverter, and an automatic level adjuster. The dedicated processor is configured to track the contents of the downstream video, data and voice information and provide refinement in control information. The refinements of control information by the dedicated processor permits data sharing, data muxing, increased security, and improved downstream bandwidth management. It shall be appreciated by those skilled in the art having the benefit of this disclosure that the smart network interface module may be a discrete module operatively coupled to the shared bus or the smart network interface module may be resident on the downstream module, or any combination thereof.

Each advanced digital downstream data module 160a through 160n is operatively coupled to an upconverter 162a through 162n, respectively. The upconverters 162a through 162n have a small footprint and are a highly integrated component of each of the advanced digital downstream data modules 160a through 160n. The small footprint for the upconverter lets the upconverter reside as an extension of the advanced digital downstream data module 160a through 160n, thereby permitting the advanced downstream data module having an upconverter to fit with a single module space shared bus chassis.

The advanced digital downstream data module 160a through 160n is configured to handle video, data and voice signals on the same QAM module. By way of example, and not of limitation, the advanced digital downstream module can be configured to perform CMTS DOCSIS-compliant modem functions and/or digital video transmissions simultaneously. The advanced digital downstream module may also be managed by software which is configured to mix and integrate different types of data, e.g. IP data signals, digital video signals, within a single platform using the MPEG-2 transport stream.

Preferably, the present invention also includes a bi-directional signaling and control module 164 which includes a downstream out-of-band Quadrature Phase Shift Keying (QPSK) transmitter 166 and an upstream QPSK receiver 168. The bi-directional signaling and control module 164 provides the two-way signaling necessary to communicate between the highly integrated computer controlled headend 100 and a plurality of set-top boxes (not shown). The bi-directional signaling and control module 164 includes a powerful embedded microprocessor which permits local control and management. The downstream out-of-band QPSK transmitter 166 is operatively coupled to an upconverter 170. It shall be appreciated by those of ordinary skill in the art that during out-of-band communications a plurality of control signals are communicated in portions of the broadband spectrum that does not contain program content.

A downstream combiner 172 receives the output from upconverter 162a through 162n and 170 performs the function of combining downstream signals. The downstream combiner 172 is an isolation device which sets gains for downstream transmission, i.e. tilt compensation, and provides system reliability with diagnostic tools. The downstream combiner 172 includes a plurality of passive and active devices which combine the upconverter 162a through 162n and 170 output. Preferably, the downstream combiner 178 monitors the “health” of each downstream encoder 160a through 160n, the downstream out-of-band QPSK transmitter 166, and their respective upconverters 162a through 162n and 170.

A diplexer 174 receives signals from the downstream combiner 170. The diplexer 174 is a high pass/low pass filter which “high” passes downstream information and “low” passes upstream information. The diplexer receives “high” pass signals from the downstream combiner 172 and submits these signals to a headend system combiner 114. The headend system combiner 114 is configured to permit combining the signals generated by an existing analog cable headend (not shown) with the modulated digital headend output generated by highly integrated computer controlled headend 100.

Referring to FIG. 3 as well as FIG. 4, the distribution network 116 receives output from the headend system combiner 114. It shall be appreciated by those of ordinary skill in the art that the distribution network includes a plurality of amplifiers and set-top boxes or modems. The set-top boxes are configured to receive signals from the highly integrated computer controlled headend 100 and the analog headend. Upstream communications generated by the set-top boxes are communicated to headend system 114 which submits the upstream communication to diplexer 174. The diplexer 174 low passes the upstream communications to an upstream distribution amplifier 176.

Referring back to FIG. 4, the upstream distribution amplifier 176 receives upstream signals from the diplexer 174. The upstream distribution amplifier 176 provides impedance matching, inverse tilt compensation, and diagnostic services for the distribution network. The upstream distribution amplifier does not demodulate upstream signals.

A plurality of upstream receiver modules 168, 178a through 178n, and 180 through 180n accept upstream data signals from the upstream distribution amplifier 176. Upstream data signals are communicated in the form of packets which contain the Internet data, telephony data, and system status/control data. Preferably, each upstream receiver module 168, 178a through 178n, and 180 through 180n includes the following components, an upstream tuner, a PCI interface, a microprocessor and memory support, encryption circuits, and buffer amplification. More particularly, upstream receiver module 168 is operatively coupled with the downstream out-of-band QPSK transmitter 166 and receives upstream communications associated with the data signals generated by the downstream out-of-band QPSK transmitter 166. The upstream receiver modules 178a through 178n receive upstream DOCSIS data and demodulated the upstream signal. The upstream receiver modules 180a through 180n receive out-of-band upstream communications from the distribution network and demodulates the upstream signal. Each upstream receiver module modules 168, 178a through 178n, and 180 through 180n is operatively coupled to the shared bus 120, and submit their demodulated output to control computer 142.

Preferably, a 32 bit Compact PCI-bus is employed. Additionally other parallel buses including a 64-bit bus, 128-bit bus, 256-bit bus and larger shared bus configurations may also be employed. Alternatively a serial bus is also used for the shared bus 120. Additionally, any combination of a parallel and serial bus may also be employed.

By having the highly integrated computer controlled headend 100 with the shared bus system, a variable quality of service (QoS) is achieved. The variable QOS differentiates between different types of data and the way the data is handled. By way of example Internet data may have an acceptable degree of delay between packets. However, voice applications can not have too much delay otherwise the quality of the voice signal is compromised. The highly integrated computer controlled headend 100 has the ability to guarantee the delivery of different types of data in a prescribed manner, and thereby meet variable QoS demands.

The highly integrated computer controlled headend 100 creates a highly flexible, scalable, and modular system design which is configured to run various applications. Additionally, the hardware platform can be configured to reduce the number of analog channels that need to be converted to digital channels thereby optimizing available bandwidth.

The software for the highly integrated computer controlled headend 100 comprises an advanced system software, a digital video broadcast module, and a CMTS headend router software module. The advanced system software wraps around the highly integrated computer controlled headend 100 and controls the advanced digital down stream data module 160a through 160n and the integrated bi-directional signaling and control module 164. In addition, the advanced operating system software creates an applications program interface (API) where external software modules can be inserted and used to run digital applications.

The digital video broadcast module expands the number of broadcast channels it offers and needs only the advanced digital down stream data module to be operational. This module is compatible with the plurality of digital set-top boxes.

The CMTS headend router software module is used to control and manage the advanced digital down stream data module and the integrated bi-directional signaling and control module. The CMTS headend router software provides router functionality to the highly integrated computer controlled headend by controlling encoding, encapsulation, error correction, handshaking, and communications protocols used by DOCSIS.

Alternatively, it shall be appreciated by those skilled in the art having the benefit of this disclosure that each of the individual smart NIMs 126, 128, 134, 138, 140 146, 148 and 150 can be combined in an aggregated smart NIM 130. Furthermore, it shall be appreciated by those skilled in the art having the benefit of this disclosure that any combination of individual smart NIMs and aggregated smart NIMs can be used to accomplish the same objective as described herein.

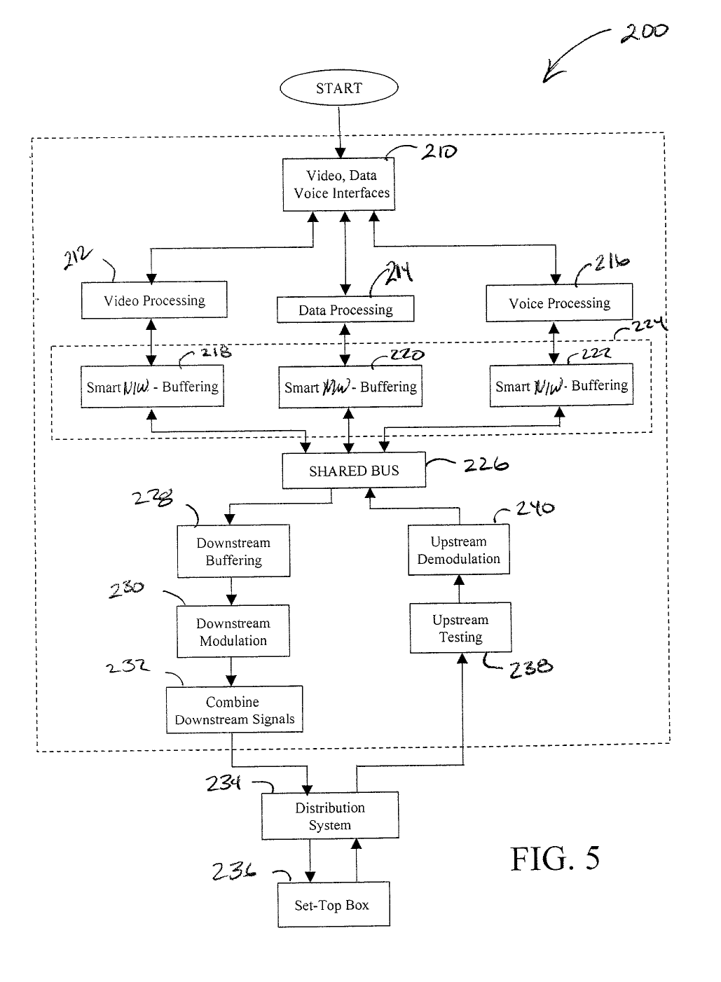

Referring to FIG. 5 there is shown a flowchart which describes the method or process 200 for combining digital video signals, digital data signals, voice signals, and upstream communications in a shared system environment described in FIG. 4. Referring to FIG. 4, the shared environment includes the shared bus 120 and buffers the various information streams within each of the smart NIMs 126, 128, 134, 138, 140 146, 148 and 150, or in the aggregated smart NIM 130. The method of combining these different information streams in the highly integrated computer controlled headend 100 is described in further detail below.

In block 210, the method or process for buffering various information streams in a shared environment is engaged by: providing a video interface for receiving digital video signals; providing a data interface for receiving digital data signals; and providing a voice interface for receiving voice signals. It shall be appreciated by those skilled in the art having the benefit of this disclosure that each of the different information streams, i.e. video, data and voice, have a plurality of associated control signals associated with each different information stream.

The video interface provides an interface for the highly integrated computer controlled digital headend 100 to receive analog video signals and communicate digital video signals. The analog video signals and digital video signals include control analog video signals and control digital video signals, respectively. The analog video signals are generated by satellite 104 and off-air communications 106. The digital video signals are communicated between the digital headend and the NOC 102. The data interface provides an interface for the digital highly integrated computer controlled headend 100 which communicates digital data signals from one or more Internet portals 108 with the digital headend 100. The digital data signals include control digital data signals. The voice interface provides an interface for the digital headend which communicates voice signals from the local telephone company portal 110 and the from the long distance telephone company portal 112. The voice signals include control voice signals.

At block 212, the digital video signals and analog video signals are processed. Preferably, the video signals are processed by the video server 144, the control computer 142, newly converted MPEG2 content computer 136, and the service computer 132. As described above, the video server 144, the control computer 142, newly converted MPEG2 content 136, and the service computer 142 are operatively coupled to smart NIMs 126, 128, 134, 138, 140, 146, 148 and 150 having 10/100BaseT interfaces and DVB-ASI/SPI interfaces as previously described, or in the alternative an aggregated smart NIM 130 or any combination thereof.

At block 214, the digital data signals are processed. As described above, the digital data signals are processed by the Internet processing and management computer 122. The Internet processing and management computer is operatively coupled to a smart NIM 126 or in the alternative an aggregated smart NIM 130 or any combination thereof.

At block 216, the voice signals are processed. As described above, the voice signals are processed by the Telephony processing and management computer 124. The Telephony processing and management computer is operatively coupled to a smart NIM 128 or in the alternative an aggregated smart NIM 130 or any combination thereof.

At block 218, buffering the digital video signals with at least one smart NIM is performed. Each smart NIM performs the function of buffering digital video signals including control digital video signals and generates buffered digital video signals. The buffered digital video signals are transmitted and received from the shared bus. Preferably, the buffered digital video signals are communicated across the shared bus in a parallel fashion. Alternatively, the buffered digital video signals are communicated using a serial bus, or any combination of a serial bus and a parallel bus.

At block 220, buffering the digital data signals with at least one smart NIM is performed. The smart NIM performs the function of buffering digital data signals including control digital data signals and generates buffered digital data signals. The buffered digital data signals are transmitted and received from the shared bus. Preferably, the buffered digital data signals are communicated across the shared bus in a parallel fashion.

At block 222, buffering the voice signals with at least one smart NIM is performed. The smart NIM performs the function of buffering voice signals including control voice signals and generates buffered voice signals. The buffered voice signals are transmitted and received from the shared bus. Preferably, the buffered voice signals are communicated across the shared bus in a parallel fashion. Alternatively, the buffered digital video signals are communicated using a serial bus, or any combination of a serial bus and a parallel bus.

At block 224, the alternative buffering of the digital video signals, digital data signals, and voice signals can be performed by an aggregated smart NIM 130. The aggregated smart NIM 130 provides the same functionality as described by blocks 218, 220, and 222. It shall be appreciated by those skilled in the art that any combination of smart NIMs could also be employed to perform the buffering, including the alternative NIMs resident on the downstream modules.

As described in FIG. 4, the digital headend preferably includes a plurality of smart NIMs or in the alternative an aggregated smart NIM or any combination thereof. The smart NIM is generally defined as a network interface module having an onboard CPU and having a plurality of memories to support buffering. The plurality of memories refer to the L1 cache, L2 cache and RAM and any other such memories.

The preferred embodiment of the present invention includes a smart NIM which can also provide the functionality of optimizing data transfer across the shared bus 120. Preferably, the smart NIM performs the operation of optimizing data transfer by judiciously employing the memory buffering available on the smart NIM to maximize the data flow across the shared bus. More particularly, the smart NIM operations optimize the data transfer across the shared bus by communicating information from the various data streams in parallel across the system bus. Therefore, the various information streams can access the shared bus simultaneously.

It shall be appreciated by those of ordinary skill in the art that a “bus” is a series of tiny wires that run from one chip to another. The shared bus 120 of the present invention provides an architecture which allows the headend 100 to share headend resources. The shared bus includes address, data and control elements which are communicated in a serial bus or parallel bus. A serial bus has fewer wires and operates generally at a higher speed. A parallel bus has more wires and generally operates at a slower speed. Any combination of a serial bus and parallel bus may also be employed. Preferably, the shared bus employs a 32-bit Compact PCI bus which is a parallel bus.

Although the preferred embodiment of the present invention employs a smart NIM configured to optimize communications across the shared bus, other devices which do not employ a CPU but which provide buffering may also be employed. These devices may include only memory devices which are configured to For purposes of this patent application, the term smart NIM is not restricted to NIM having a CPU. As described in this patent application, the term the smart NIM refers to a NIM which is configured to buffer digital information received by the NIM. Preferably, the buffered digital information may be optimized by the smart NIM for transfer across the shared bus.

At block 226, the communications across the shared bus are performed. As described in FIG. 4, due to cost constraints the shared bus 120 is preferably a 32-bit Compact PCI bus. Alternatively, the buffered digital video signals are communicated using a serial bus, or any combination of a serial bus and a parallel bus. It shall be appreciated by those skilled in the art that the alternative bus architecture may be employed. The communications which are performed across the shared bus are two-way communications. Downstream communications which are buffered and optimized by the smart NIMs 126, 128, 134, 138, 140 146, 148 and 150 and in the alternative aggregated smart NIM 150 are communicated across the shared bus to a downstream module 160a through 160n. Upstream communications are also communicated across the shared bus. Upstream communications are generated by at least one set-top box and demodulated before being communicated across the shared bus, and then transmitting the upstream communications to the smart NIMs 126, 128, 134, 138, 140 146, 148 and 150 and in the alternative aggregated smart NIM 130, or downstream module 160a through 160n.

At block 228, downstream buffering is performed. Preferably the downstream buffering is performed so that the downstream modulation is optimized. Preferably, the downstream signal which is buffered is configured as an MPEG-2 transport stream. Additionally, the downstream buffering provides for the addition of control data to the MPEG-2 transport stream. Control data is added to the MPEG-2 transport stream in a process which spreads the MPEG-2 data packets apart. After having spread the MPEG-2 data packets apart one or more control data packets are added. The new control data packets include and providing for the addition of control data packets. The control data packets added to the MPEG-2 transport stream include URLs, indicia of interest, overlays, targeted advertising, and other data which can be used in an interactive environmnent. It shall be appreciated by those skilled in the art having the benefit of this disclosure that the smart network interface module may be a discrete module operatively coupled to the shared bus or the smart network interface module may be resident on the downstream module, or any combination thereof.

At block 230, downstream modulation is performed. The downstream modulation includes QAM, QPSK and any other such modulation scheme in which digital data is converted to an analog carrier signal. It shall be appreciated by those skilled in the art having the benefit of this disclosure that additional functions such as forward error correction are also employed during the process of downstream modulation.

At block 232, downstream signals are combined. Preferably, the downstream signals ire combined at the downstream combiner 172 and at the headend system combiner 114. Preferably, the process of combining video, data and voice signals also includes combining the modulated digital signals with the downstream combiner 114. Preferably, the headend system combiner 114 combines the analog headend output 115 with the output from the downstream combiner 172 for transmission via the distribution network 116.

At block 234, the downstream signals are communicated across a distribution network. The distribution network includes cable only distribution networks, hybrid fiber cable systems, wireless systems, and any other such distribution network.

At block 236, a set-top box receives the downstream signals from the distribution network and communicates the downstream signals to a display screen. A user may then interact with the downstream signal by generating an upstream communication in a manner consistent with systems and methods well known to those skilled in the art. Generally, the upstream communications generated by a user includes information submitted by the user to the set-top box. Preferably the upstream communications includes a plurality of test signals. The plurality of test signals are used to determine the noisy upstream channels and the upstream channels that have little or no noise.

At block 234, the upstream communication is communicated to the digital head 100 end by way of the distribution network 116. Preferably, the upstream communication includes a plurality of test signals as described above. Preferably, the distribution network is configured to use the test signals generated by the set-top boxes to determine the which channels are noisy and which channels have little or no noise and which channels with little or no noise are available for upstream communications.

At block 238, the upstream communication with the test signals are processed and a final assessment is made of which channels are noisy, which channels have little or no noise, and which channels have available bandwidth for upstream communications. The results generated by the test signals are then included in the upstream communications signals. Therefore, in the preferred embodiment, the upstream communication signals generated by the set-top box includes information submitted to the set-top box, the test signals, and the results generated by the test signals.

At block 240, the upstream communication signals are demodulated and communicated across the shared bus 120 to the smart NIM 126, 128, 134, 138, 140 146, 148 and 150 or in the alternative the aggregated smart NIM 130 for buffering. Furthermore, the upstream communication signals are also parsable into user generated set-top box signals, and distribution test signals. User generated set-top box upstream signals are communicated across the shared bus to the smart NIM which then communicates the upstream signals to the video, data, or voice processing. The distribution test signals are communicated to the downstream buffering block via the shared bus 120. The distribution test signals are then incorporated in the downstream channel and communicated to the set-top box to optimize the use of the upstream channels.

It shall be appreciated by those of ordinary skill in the art having the benefit of this disclosure that although a reference is made to only one set-top box, a distribution network includes a plurality of set-top boxes. Additionally, it shall be appreciated by those of ordinary skill in the art having the benefit of this disclosure that the set-top box referred to in this specification also refers to a “cable modem.”

While embodiments and applications of this invention have been shown and described, would be apparent to those skilled in the art that many more modifications than mentioned above are possible without departing form the inventive concepts herein. The invention, therefore, is not to be restricted except in the spirit of the appended claims.

What is claimed is:

1. A two-way broadband system, comprising:
a digital headend configured to process a plurality of digital video, a plurality of digital data, a plurality of voice information, and a plurality of upstream communications, said digital headend including,
at least one smart network interface module configured to buffer said plurality of digital video, said plurality of digital data, said plurality of voice information and said plurality of upstream communications,
a shared bus operatively coupled to said at least one smart network interface module, said shared bus configured to transport said digital video, said plurality of digital data, said plurality of voice information, and said plurality of upstream communications,
a downstream module operatively coupled to said shared bus, said downstream module configured to transmit said plurality of digital video, said plurality of digital data and said plurality of voice information,
an upstream module operatively coupled with said shared bus, said upstream configured to receive said plurality of upstream communications;
a cable distribution network in communications with said digital headend, said cable distribution network configured to communicate a plurality of digital video, a plurality of digital data, a plurality of voice information, and a plurality of upstream communications; and
a set-top box configured to receive said plurality of video, said plurality of data, said plurality of voice information, said set-top box configured to generate said plurality of upstream communications.

2. The two-way broadband system of claim 1 wherein said at least one smart network interface module is operatively coupled to a control computer, said control computer configured to perform content management and resource allocation.

3. The two-way broadband system of claim 2 wherein said at least one smart network interface module is operatively coupled to a service computer, said service computer configured to manage conditional access.

4. The two-way broadband system of claim 3 wherein said at least one smart network interface module is operatively coupled to a video server, said video server configured to provide local storage for digital video.

5. The two-way broadband system of claim 4 wherein said at least one smart network interface module is operatively coupled to an Internet computer, said Internet computer configured to communicate Internet data.

6. The two-way broadband system of claim 5 wherein said at least one smart network interface module is operatively coupled to a telephony computer, said telephony computer configured to communicate telephony data.

7. The two-way broadband system of claim 6 wherein said telephony computer comprises a switched telephony system, said switched telephony system configured to communicate telephony data.

8. The two-way broadband system of claim 6 wherein said telephony computer comprises a Voice over IP system, said Voice over IP system configured to communicate telephony data.

9. The two-way broadband system of claim 6 wherein said at least one smart network interface module is configured to optimize the transfer of a plurality of bits associated with said plurality of digital video, said plurality of digital data, said plurality of voice information and said plurality of upstream communications across said shared bus.

10. The two-way broadband system of claim 1 wherein said at least one smart network interface module is configured to buffer said plurality of digital video, said plurality of digital data, said plurality of voice information and said plurality of upstream communications.

11. The two-way broadband system of claim 10 wherein said at least one smart network interface module is configured to buffer a plurality of digital video control data associated with said plurality of digital video.

12. The two-way broadband system of claim 12 wherein said at least one smart network interface module is configured to buffer a plurality of digital data control data associated with said plurality of digital data.

13. The two-way broadband system of claim 13 wherein said at least one smart network interface module is configured to buffer a plurality of voice information control data associated with said plurality of voice information.

14. The two-way broadband system of claim 14 wherein said at least one smart network interface module is configured to buffer a plurality of upstream communications control data associated with said plurality of upstream communications.

15. A two-way broadband system, comprising:
a digital headend configured to process a plurality of digital video, a plurality of digital data, and a plurality of upstream communications, said digital headend including,
at least one smart network interface module configured to buffer said plurality of video, said plurality of digital data, and said plurality of upstream communications,
a shared bus operatively coupled to said smart network interface module, said shared bus configured to transport said digital video, said plurality of digital data, and said plurality of upstream communications,
a downstream module operatively coupled to said shared bus, said downstream module configured to transmit said plurality of digital video and said plurality of digital data,
an upstream module operatively coupled with said shared bus, said upstream configured to receive said plurality of upstream communications;
a cable distribution network in communications with said digital headend, said cable distribution network configured to communicate a plurality of digital video, a plurality of digital data, and a plurality of upstream communications; and
a set-top box configured to receive said plurality of video, said plurality of data, said plurality of voice information, said set-top box configured to generate said plurality of upstream communications.

16. The two-way broadband system of claim 15 wherein said smart network interface module is operatively coupled to a control computer, said control computer configured to perform content management and resource allocation.

17. The two-way broadband system of claim 16 wherein said smart network interface module is operatively coupled to a service computer, said service computer configured to configured to manage conditional access.

18. The two-way broadband system of claim 17 wherein said smart network interface module is operatively coupled to a video server, said video server configured to provide local storage for digital video.

19. The two-way broadband system of claim 18 wherein said smart network interface module is operatively coupled to an Internet computer, said Internet computer configured to communicate Internet data.

20. The two-way broadband system of claim 19 wherein said at least one smart network interface module is configured to optimize the transfer of a plurality of bits associated with said plurality of digital video, said plurality of digital data, said plurality of voice information and said plurality of upstream communications across said shared bus.

21. The two-way broadband system of claim 15 wherein said at least one smart network interface module is configured to buffer said plurality of digital video, said plurality of digital data, said plurality of voice information and said plurality of upstream communications.

22. The two-way broadband system of claim 21 wherein said at least one smart network interface module is configured to buffer a plurality of digital video control data associated with said plurality of digital video.

23. The two-way broadband system of claim 22 wherein said at least one smart network interface module is configured to buffer a plurality of digital data control data associated with said plurality of digital data.

24. The two-way broadband system of claim 23 wherein said at least one smart network interface module is configured to buffer a plurality of voice information control data associated with said plurality of voice information.

25. The two-way broadband system of claim 24 wherein said at least one smart network interface module is configured to buffer a plurality of upstream communications control data associated with said plurality of upstream communications.

26. A digital headend configured to receive a plurality of digital video, a plurality of data signals, a plurality of voice information, and a plurality of upstream communications, said digital headend comprising:
a smart network interface module housed within said digital headend, said smart network interface module configured to buffer said plurality of video, said plurality of data, said plurality of voice information and said plurality of upstream communications;
a shared bus operatively coupled to said smart network interface module, said shared bus configured to transport said digital video, said plurality of digital data, said plurality of voice information, and said plurality of upstream communications;
a downstream module operatively coupled to said shared bus, said downstream module configured to communicate said plurality of digital video, said plurality of digital data and said plurality of voice information; and
an upstream module operatively coupled to said shared bus, said upstream module configured to receive said plurality of upstream communications and communicate said upstream communications to said shared bus.

27. The digital headend of claim 26 wherein said at least one smart network interface module is operatively coupled to a control computer, said control computer configured to perform content management and resource allocation.

28. The digital headend of claim 26 wherein said at least one smart network interface module is operatively coupled to a service computer, said service computer configured to manage conditional access.

29. The digital headend of claim 26 wherein said at least one smart network interface module is operatively coupled to a video server, said video server configured to provide local storage for digital video.

30. The digital headend of claim 26 wherein said at least one smart network interface module is operatively coupled to an Internet computer, said Internet computer configured to communicate Internet data.

31. The digital headend of claim 26 wherein said at least one smart network interface module is operatively coupled to a telephony computer, said telephony computer configured to communicate telephony data.

32. The digital headend of claim 31 wherein said telephony computer comprises a switched telephony system, said switched telephony system configured to communicate telephony data.

33. The digital headend of claim 31 wherein said telephony computer comprises a Voice over IP system, said Voice over IP system configured to communicate telephony data.

34. The digital headend of claim 26 wherein said at least one smart network interface module is configured to optimize the transfer of a plurality of bits associated with said plurality of digital video, said plurality of digital data, said plurality of voice information and said plurality of upstream communications across said shared bus.

35. The digital headend of claim 26 wherein said at least one smart network interface module is configured to buffer said plurality of digital video, said plurality of digital data, said plurality of voice information and said plurality of upstream communications.

36. The digital headend of claim 35 wherein said at least one smart network interface module is configured to buffer a plurality of digital video control data associated with said plurality of digital video.

37. The digital headend of claim 36 wherein said at least one smart network interface module is configured to buffer a plurality of digital data control data associated with said plurality of digital data.

38. The digital headend of claim 37 wherein said at least one smart network interface module is configured to buffer a plurality of voice information control data associated with said plurality of voice information.

39. The digital headend of claim 38 wherein said at least one smart network interface module is configured to buffer a plurality of upstream communications control data associated with said plurality of upstream communications.

40. A digital headend configured to receive a plurality of digital video, a plurality of data signals, and a plurality of upstream communications, said digital headend comprising:
a smart network interface module housed within said digital headend, said smart network interface module configured to buffer said plurality of video, said plurality of data, and said plurality of upstream communications;
a shared bus operatively coupled to said smart network interface module, said shared bus configured to transport said digital video, said plurality of digital data, and said plurality of upstream communications;
a downstream module operatively coupled to said shared bus, said downstream module configured to communicate said plurality of digital video and said plurality of digital data; and
an upstream module operatively coupled to said shared bus, said upstream module configured to receive said plurality of upstream communications and communicate said upstream communications to said shared bus.

41. The digital headend of claim 40 wherein said smart network interface module is operatively coupled to a control computer, said control computer configured to perform content management and resource allocation.

42. The digital headend of claim 41 wherein said smart network interface module is operatively coupled to a service computer, said service computer configured to manage conditional access.

43. The digital headend of claim 42 wherein said smart network interface module is operatively coupled to a video server, said video server configured to provide local storage for digital video.

44. The digital headend of claim 43 wherein said smart network interface module is operatively coupled to an Internet computer, said Internet computer configured to communicate Internet data.

45. The digital headend of claim 44 wherein said at least one smart network interface module is configured to optimize the transfer of a plurality of bits associated with said plurality of digital video, said plurality of digital data, said plurality of voice information and said plurality of upstream communications across said shared bus.

46. The digital headend of claim 40 wherein said at least one smart network interface module is configured to buffer said plurality of digital video, said plurality of digital data, said plurality of voice information and said plurality of upstream communications.

47. The digital headend of claim 46 wherein said at least one smart network interface module is configured to buffer a plurality of digital video control data associated with said plurality of digital video.

48. The digital headend of claim 47 wherein said at least one smart network interface module is configured to buffer a plurality of digital data control data associated with said plurality of digital data.

49. The digital headend of claim 48 wherein said at least one smart network interface module is configured to buffer a plurality of voice information control data associated with said plurality of voice information.

50. The digital headend of claim 49 wherein said at least one smart network interface module is configured to buffer a plurality of upstream communications control data associated with said plurality of upstream communications.
